(19) United States
(12) Patent Application Publication
(10) Pub. No.: US 2005/0036769 A1
(43) Pub. Date: Feb. 17, 2005

(54) Radiator fan driving module applied to a power system or a power supply device

(75) Inventors: Alan Yu, Taipei Hsien (TW); Andraw Ho, Taoyuan Hsien (TW); Frank Wang, Taipei (TW)

Correspondence Address: Troxell Law Office PLLC, Suite 1404, 5205 Leesburg Pike, Falls Church, VA, 22041, US

(73) Assignee: Phoenixtec Power Co., Ltd.

(21) Appl. No.: 10/640,001

(22) Filed: Aug. 14, 2003

(51) Int. Cl. H02P 7/29

(52) U.S. Cl. 388/829

(57) ABSTRACT

A radiator fan driving module applied to a power system/power supply device is configured as a single unit on which a fan driving circuit is designed, whereby the amount of the radiator fans is easy to be varied based on requirements of the power system. The fan driving circuit controlled by a PWM circuit applies a DC voltage to the radiator fan whereby the radiator fan is driven at a PWM voltage with a non-zero low level voltage, thus the driving current to the radiator fan is smooth and the lifetime of the radiator fan is prolonged because stress that the radiator fan bearing bear is minimized. The PWM circuit further addresses temperature and load condition to improve the operation efficiency of the radiator fan by speeding up while temperature is too high, and slowing down while the load that the power system experiences is light.

### BACKGROUND OF THE INVENTION

1. Field of Invention

The present invention relates to a radiator fan driving module applied to a power system or a power supply device, and more particularly to a radiator fan driving module that is able to be increased in the amount based on the requirement of the power system. Further, the driving module is capable of driving a radiator fan easily to reduce the energy consumption and to reduce the stress on the fan bearing whereby the lifetime of the fan is prolonged.

2. Related Art

As the configuration of computer equipment and peripheral instruments becomes more precise, higher power quality is accordingly required. For example, because more and more electrical instruments can not accept the power supply to be interrupted suddenly, the UPS (uninterruptible power supply) device is employed. When the input alternating current (AC) voltage is suddenly interrupted, the UPS can immediately and continually supply voltage to the load. As mentioned above, when the instrument design becomes more precise, the power supply is required to have superior reliability. Thus, in consideration of that a single UPS may not provide a stable power supply, a kind of configuration composed of multiple UPSs connected in parallel is devised. The total amount of the UPSs in the configuration is adjustable based on the requirement of the power system.

Moreover, the power system and the power supply device are both for power conversion to provide different voltages or currents required by different loads in the instruments. Because the power system and the power supply are both designed to provide a great quantity of energy, the heat generated due to power conversion must be dissipated so that the power system can operate normally. The radiator fan is often applied to the power system as a heat dissipation device. The driving and control means for the radiator fan are well known. For example, the PWM (pulse width modulation) driving circuit is often applied to control the rotation speed of the radiator fan. The driving circuit can further detect whether the radiator fan has any failure based on a fan speed signal and then adjust the fan speed immediately. For a power system or a power supply device, temperature is an important factor that may influence the operation. Thus, the strict control and driving quality for the radiator fan accordingly are required.

The radiator fan applied in the power system or the power supply device is controlled by an individual circuit. Thus when the quantity of the radiator fan must be increased to meet a new heat dissipation requirement caused by the expanded power system or the power supply device, all driving circuits must be re-configured. For the manufacturers of the power system or the power supply device, it is difficult to re-configure the driving circuits of the radiator fans to meet different requirements. Further, when the quantity of the radiator fans is increased, it is difficult to consider the operation stability and the efficiency thereof.

From the foregoing instruction, it is difficult to vary the conventional fan driving circuit in the power system or power supply device in response to the change of the power system design. Moreover, some factors such as the circuit design complexity and the operation stability etc. are hard to control.

Conventionally, the activation and the rotation speed of the radiator fan is controlled by pulse width modulation (PWM) signals, where the voltage level of the PWM signals is alternately switched between a high voltage level (VCC) and a low voltage level (0 volt). Therefore, a large and sudden current will apply to the radiator fan while the voltage level is instantly changed from the low level to high level.

A radiator fan driving module in accordance with the present invention obviates or mitigates the aforementioned drawbacks.

### SUMMARY OF THE INVENTION

The main objective of the present invention is to provide a radiator fan driving module that is easy to be increased in the amount in accordance with the requirement of the power system, easily drives the radiator fan and reduces the power consumption and the stress borne by the radiator bearing, so the lifetime of the radiator fan is long.

To achieve the objective, the driving module is formed as a single unit on which at least one fan driving circuit controlled by an external PWM circuit is designed. One output terminal of the fan driving circuit is connected with a radiator fan, wherein the speed of the radiator fan is in response to the pulse width of PWM signals output from the PWM circuit. Further, a DC voltage is applied to the radiator fan to maintain the radiator fan being drived at a PWM voltage with a non-zero low level voltage, so that the radiator fan is able to be driven smoothly and operated steadily.

The driving circuit is composed of a switching transistor and at least one driving transistor. The base of the switching transistor is connected to the output terminal of the PWM circuit through a resistor, and the emitter of the switching transistor is coupled to the radiator fan through the driving transistor. Further, a resistor and a Zener diode connected in parallel are coupled between the collector and the emitter of the driving transistor, wherein the radiator fan is connected between an operating voltage and the collector of the driving transistor.

With such a circuit configuration, because the driving transistor has the Zener diode set between the collector and the emitter, a DC voltage (VCC-V_{ZD}) is applied to drive the radiator fan being rotated at a pre-determined minimum speed. VCC, which drives the radiator fan to rotate at the maximum speed, is an operating voltage applied to the driving module and V_{ZD} is the Zener voltage. Therefore, the radiator fan could be speeded up by rising the duty cycle of the PWM signals from 0% to 100%. The effect caused from the duty cycle change between 0% to 100% is equal to an effect that the average voltage of the PWM signals is changed between the (VCC-VZC) to VCC.

That is to say, only a small voltage value equal to the Zener voltage V_{ZD} is changed in every PWM cycle to control the speed of the radiator fan. Thereby, the driving current flowing through the radiator fan is more smooth and operated steadily. The stress that the fan bearing bears is minimized to prolong the lifetime of the radiator fan.

A speed detection circuit with an input terminal connects to the output terminal of the driving circuit to detect whether the radiator fan has any failure or is seized up.

A node that the driving circuit and the speed detection circuit connect together is utilized as a speed common detection terminal. When multiple driving modules are configured in parallel, the speed common detection terminal of the driving modules are connected together, whereby only one speed detection circuit is necessary and shared by all the driving modules to simplify the circuit design.

The single unit is fabricated as a printed circuit board (PCB) with an edge along which plural terminals are formed. Each terminal at the edge is correspondingly and electrically connected to a particular node of the circuits designed on the PCB, whereby the PCB is able to insert into a connector of the external control system via the plural terminals. Moreover, the PCB is able to be directly mounted on other circuit boards. With such a module design, the quantity of the radiator fans and the driving modules is able to be adjusted easily.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a radiator fan driving module in accordance with the present invention;

FIG. 2 is a circuit diagram of a driving circuit in accordance with the present invention;

FIG. 3 is a circuit diagram showing a part of the driving circuit in FIG. 2;

FIG. 4 is an operation circuit diagram showing a driving transistor in FIG. 3 is not driven;

FIG. 5 is an operation circuit diagram showing a driving transistor in FIG. 3 is driven;

FIG. 6 is a block diagram showing plural fan driving modules in accordance with the present invention connected in parallel; and

FIG. 7 is a circuit diagram of a temperature detecting circuit applied to the present invention.

### DETAILED DESCRIPTION OF THE INVENTION

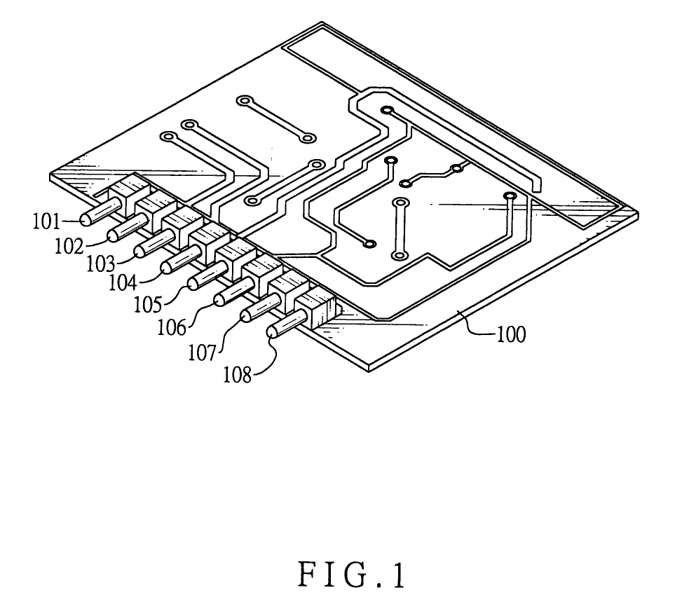

With reference to FIG. 1, a fan driving circuit and other related circuits and components are constructed on a printed circuit board (PCB)(100). A plurality of terminals (101-108) is formed along one edge of the PCB (100) so as to construct a complete single module. Each terminal (101-108) is correspondingly and electrically connected to a particular node of the circuits designed on the PCB (100), whereby signals can be output or input to the PCB (100) through these terminals (101-108). The terminals (101-108) can be inserted into a connecting interface of an external control system (not shown). Otherwise, the driving module can be directly mounted on a PCB to connect to an external control system, a radiator fan or other status detecting circuits through the PCB. Therefore, the external control system can drive the radiator fan through the driving module and detect whether the radiator fan is operated normally through the driving module. Moreover, the external control system also can obtain the temperature of the power system or the power supply device through the assistance of a temperature detecting circuit (20) as shown in FIG. 7.

Based on the detected status data, the external control system can control the speed of the radiator fan to increase the efficiency of the fan.

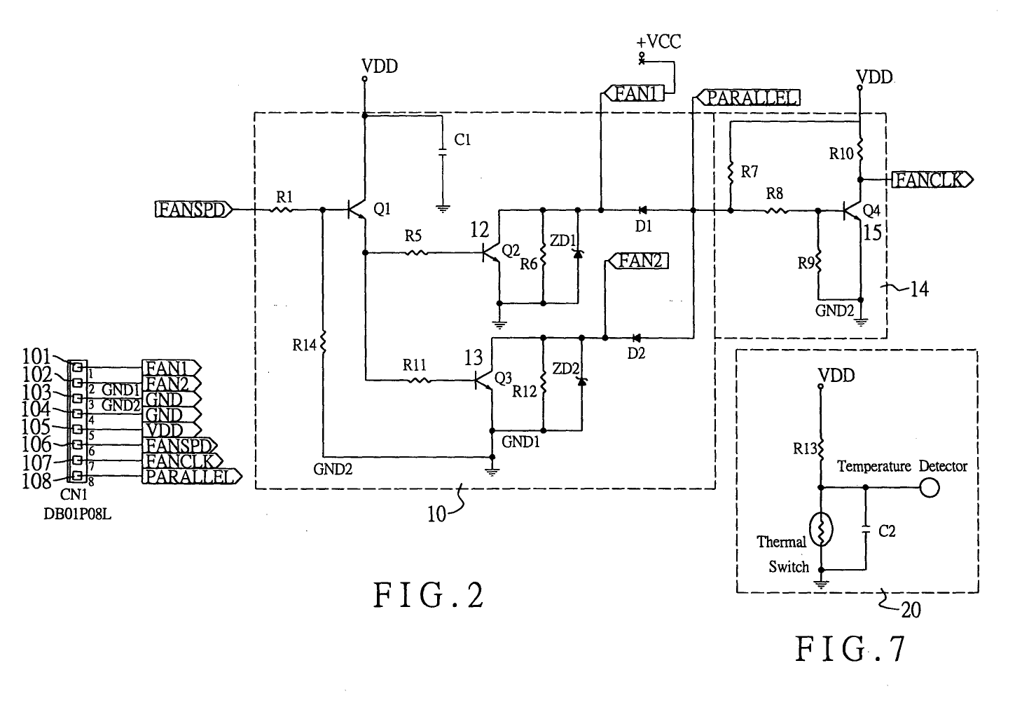

With reference to FIG. 2, the circuits designed on the PCB (100) at least include a driving circuit (10) that is controlled by a pulse width modulation (PWM) circuit (not shown) of an external control system. The output terminals of the driving circuit (10) connect to a radiator fan, where the fan speed is determined by the duty cycle of the PWM signals output from the PWM circuit.

The driving circuit (10) comprises a switching transistor (11) and at least one driving transistor, wherein the embodiment discloses two driving transistors (12)(13). The base of the switching transistor (11), through a resistor (R1), connects to a fan speed control terminal (denoted with FANSPD), i.e. the terminal (106). The external pulse signals are input to the driving circuit (10) through the terminal (106). The emitter of the switching transistor (11) is connected to the bases of the two driving transistors (12)(13). Each driving transistor (12)(13) has a resistor (R6)(R12) and a Zener diode (ZD1)(ZD2) connected between the emitter and the collector in parallel. The collector of each driving transistor (12)(13) is used as a fan terminal (FAN1)(FAN2), i.e. the terminals (101)(102), for connection with the radiator fan.

Because the Zener diodes (ZD1)(ZD2) are connected between the collector and the emitter of the driving transistors (12)(13), a DC voltage (Vcc-V_{ZD}) volts is provided on the radiator fan, wherein such a DC voltage is deemed as a DC voltage component of the PWM signals. With such a DC voltage, during the period that the fan is rotating, the variation of the driving current flowing through the radiator fan is small.

In the prior art, the lower voltage level of every PWM cycle applied to the radiator fan is zero, so that the a large voltage change range in each PWM cycle is from the zero voltage to Vcc. When Comparing the prior art with the present invention, the driving current flowing through the radiator fan in the present invention is smoother than that in the prior art. The detailed description about the DC voltages of every PWM cycle will be given later.

Further, the driving circuit (10) is connected to a speed detection circuit (14) that has an output terminal connected to the collectors of the two driving transistors (12)(13) through two diodes (D1)(D2) to detect if the radiator fan is seized up. The speed detection circuit (14) is composed of a transistor (15) and several resistors (R7-R10), wherein the collector of the transistor (15) is used as a fan lock detection terminal (FANCLK), i.e. the terminal (107) on PCB (100), which allows the external control system to detect whether the radiator fan is seized up.

A speed common detection terminal (PARALLEL), i.e. the terminal (108), is taken from a node where the driving circuit (10) and the speed detection circuit (14) connect. When multiple driving modules are connected in parallel, each speed common detection terminal (PARALLEL) of each module is connected together, whereby all the driving modules share only one speed detection circuit (14) to simplify the external circuit design.

The ground of the driving circuit (10) is connected to the terminals (GND1) (GND2), i.e. the terminals (103)(104) on the PCB (100).

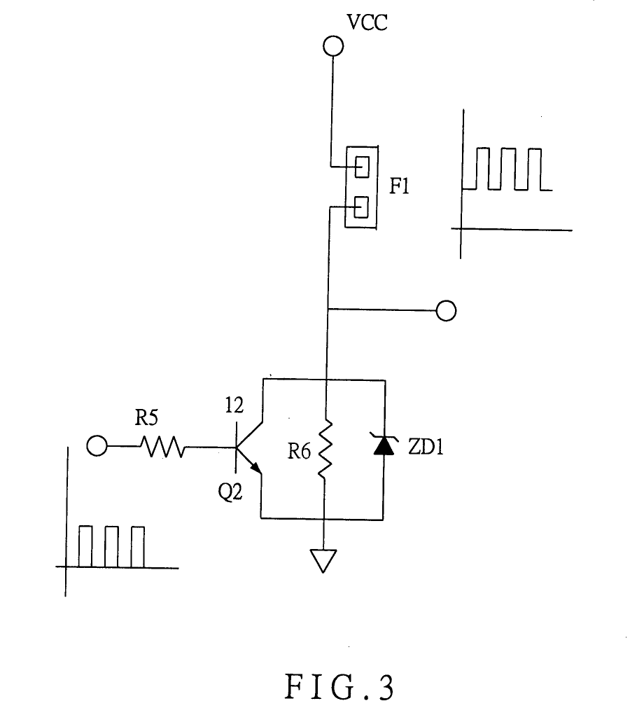

With reference to FIG. 3, a part of the driving circuit (10) shown in the drawing comprises the driving transistor (12), the resistor (R6), the Zener diode (ZD1) and a radiator fan (F1) that connects to the collector of the driving transistor (12). A waveform as shown in the left side is deemed as the input pulse signals applied to the base of the driving transistor (12). Because the Zener diode (ZD1) just crosses between the collector and the emitter of the driving transistor (12), a Zener voltage (V_{ZD}) will exist at the collector when the driving transistor (12) is not driven.

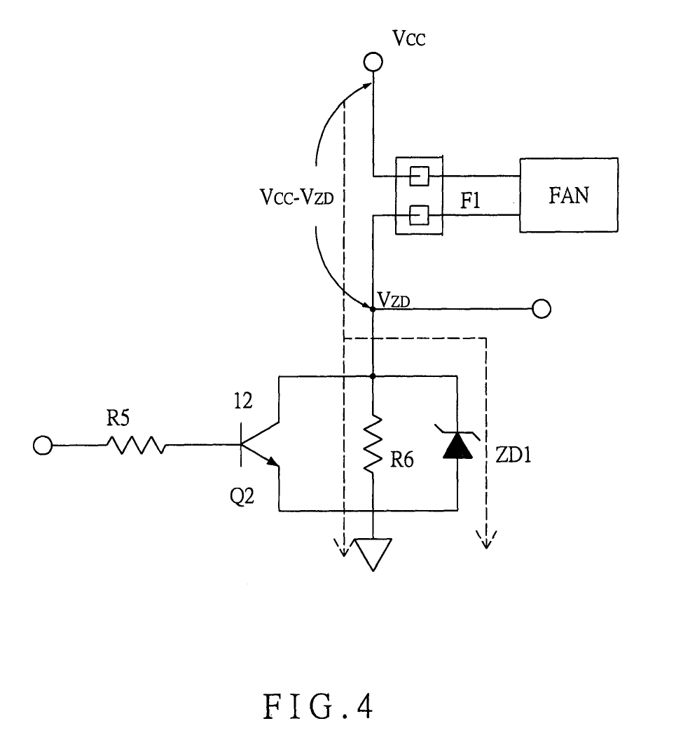

With reference to FIG. 4, during the period that the driving transistor (12) is not activated, the Zener diode generates the Zener voltage (V_{ZD}) at the collector of the driving transistor (12), i.e. at one end of the radiator fan (F1). Therefore, the voltage value across on the radiator fan (F1) is only the difference value between the operating voltage (VCC) and the Zener voltage (V_{ZD}), VCC-V_{ZD}. Even when the driving transistor (12) is not activated, the radiator fan (F1) is still driven by the DC voltage VCC-V_{ZD}.

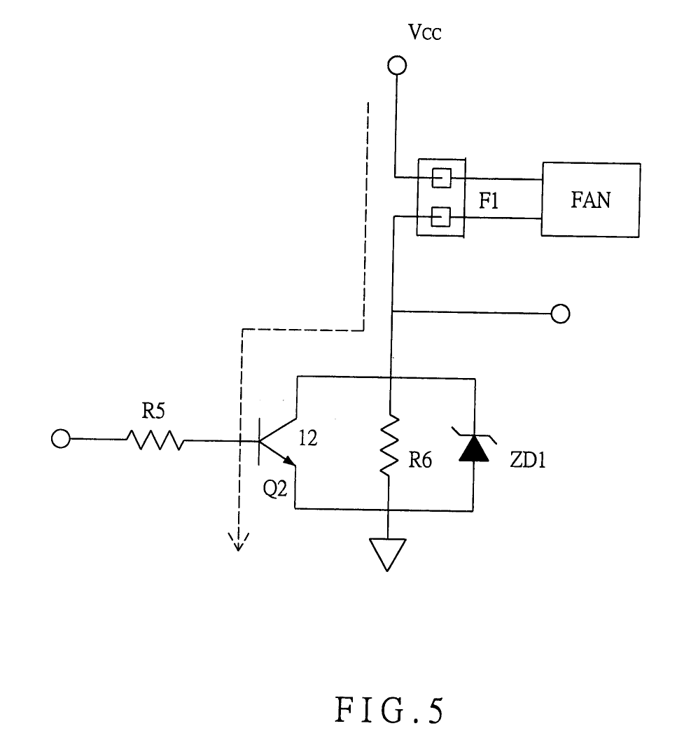

With reference to FIG. 5, when the driving transistor (12) is activated, the DC current from the operating voltage (VCC) flows through the radiator fan (F1) and the driving transistor (12) to the ground. Meanwhile, since a DC voltage (VCC-V_{ZD}) has already existed in the radiator fan, the speed control for radiator fan (F1) is more smoothly while the radiator fan is kept in the rotating status.

Furthermore, the stress on the radiator fan bearing also can be decreased thereby prolonging the lifetime of the fan.

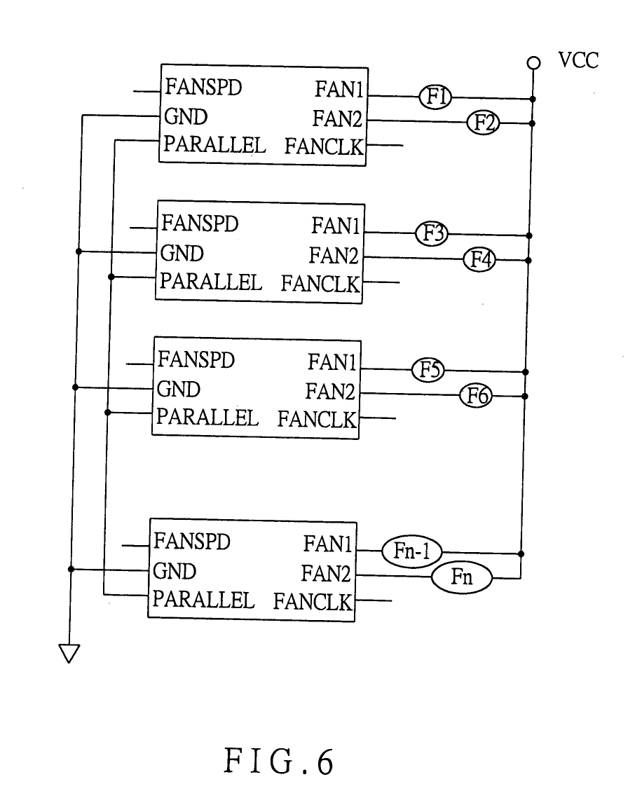

In the driving circuit (10), each driving transistor (12) is to connect and drive a radiator fan. However, the present invention can also apply to drive multiple radiator fans. With reference to FIG. 6, multiple driving modules are provided to drive the radiator fans (F1 to Fn). In the parallel configuration, all speed common detection terminals (PARALLEL) of the driving modules are connected together, whereby the external control system is able to detect whether any of the radiator fans is seized up just through one fan lock detection terminal (FANCLK) in one of the driving modules.

Because the driving module is controlled by the external PWM signals, some factors that may have influence on the rotation speed of the radiator fans can also be addressed. For example, with reference to FIG. 7, a temperature detecting circuit (20) is used to detect the temperature value of the power system or the power supply device. When the temperature is excessive, the external PWM circuit will speed up the radiator fan through the control of the driving module. On the contrary, when the temperature is low, the PWM control circuit will slow down the radiator fan to have a superior operation efficiency.

A further factor that determines the rotation speed is the condition of the load. When the power system or the power supply device has a heavy load, the heat dissipation requirement should be increased so the PWM circuit also speeds up the radiator fan. Otherwise, if the power system experiences a light load, the PWM circuit decelerates the radiator fan to decrease the power consumption.

From the foregoing description, the radiator fan driving circuit for the power system or the power supply device is designed to form a module. With such a modular design, the amount of the radiator fans or the driving circuits is easy to expand depending on the different heat dissipation requirements of the power system. For the power system manufacturers or the designers, it is convenient to achieve the objective of heat dissipation based on the different specification requirements.

The invention may be varied in many ways by a skilled person in the art. Such variations are not to be regarded as a departure from the spirit and scope of the invention, and all such modifications are intended to be included within the

1. A radiator fan driving module adapted to apply to a power system or a power supply device, wherein the radiator fan driving module is formed as a single unit having at least one driving circuit that is adapted to be controlled by an external PWM circuit, wherein an output terminal of the driving circuit is adapted to connect to at least one radiator fan, wherein a DC voltage is applied to the radiator fan to maintain the radiator fan being driven at a PWM voltage with a non-zero low level voltage, so that the radiator fan is able to be driven smoothly and operated steadily.

2. The radiator driving module as claimed in claim 1, the driving circuit being composed of a switching circuit and at least one driving circuit, wherein a base of the switching transistor is connected to the PWM circuit through a resistor, and a collector of the switching transistor is coupled to the radiator fan through the driving transistor, wherein a resistor and a Zener diode connected in parallel are coupled between a collector and an emitter of the driving transistor, and the radiator fan is connected between an operating voltage and the collector of the driving transistor.

3. The radiator fan driving module as claimed in claim 2, wherein a speed detection circuit with an input terminal connects to the output terminal of the driving circuit to detect whether the radiator fan has any failure or is seized up.

4. The radiator fan driving module as claimed in claim 3, wherein a node that the driving circuit and the speed detection circuit connect together being utilized as a speed common detection terminal, wherein when multiple driving modules are configured in parallel, the speed common detection terminal of the driving modules are connected together, whereby only one speed detection circuit is necessary and shared by all the driving modules.

5. The radiator fan driving module as claimed in claim 1, wherein the single unit is fabricated as a printed circuit board (PCB) with an edge along which plural terminals are formed, wherein the terminals at the edge are electrically connected to nodes of the circuit on the PCB, so that the terminals are able to be adapted to insert into a connector of the external control system.

6. The radiator fan driving module as claimed in claim 4, wherein the single unit is fabricated as a printed circuit board (PCB) with an edge along which plural terminals are formed, wherein the terminals at the edge are electrically connected to nodes of the circuit on the PCB, so that the terminals are able to be adapted to insert into a connector of the external control system.

7. The radiator fan driving module as claimed in claim 1, wherein the single unit is fabricated as a printed circuit board (PCB) with an edge along which plural terminals are formed, wherein the terminals at the edge are electrically connected to nodes of the circuit on the PCB, so that the terminals are able to be adapted to mount on at least one other circuit boards.

8. The radiator fan driving module as claimed in claim 4, wherein the single unit is fabricated as a printed circuit board (PCB) with an edge along which plural terminals are formed, wherein the terminals at the edge are electrically connected to nodes of the circuit on the PCB, so that the terminals are able to be adapted to mount on at least one other circuit board.
